(19) United States
(12) Patent Application Publication
(10) Pub. No.: US 2023/0385076 A1
(43) Pub. Date: Nov. 30, 2023

(54) METHOD FOR OPERATING A CONTROL UNIT ON WHICH MULTIPLE APPLICATIONS ARE EXECUTED

(71) Applicant: Robert Bosch GmbH, Stuttgart (DE)

(72) Inventors: Nils Boecher, Wiesbaden (DE); Gregor Blott, Salzgitter (DE)

(21) Appl. No.: 18/250,562

(22) PCT Filed: Dec. 16, 2021
(86) PCT No.: PCT/EP2021/086071

§ 371 Date: Apr. 26, 2023

(30) Foreign Application Priority Data
Dec. 21, 2020 (DE) 10 2020 216 380.4

(51) Int. Cl. G06F 9/445; G06F 21/57; G06F 21/51

(52) U.S. Cl. CPC G06F 9/44521; G06F 21/57; G06F 21/51

(57) ABSTRACT

A method for operating a control unit on which multiple applications are executed. The method includes: using a reference stored permanently in the control unit, obtaining a first code block of a first application; using verification information stored permanently in the control unit, checking whether the first code block is in a version corresponding to the verification information; in response to the result of the check being positive, approving the program code in the first code block for execution; using a reference in the first code block, obtaining a transfer block which contains a reference to a further code block of a further application; using verification information stored in the first code block, checking whether the transfer block is in a version corresponding to the verification information; in response to the result of the check being positive, obtaining the further code block using the reference in the transfer block.

### FIELD

The present invention relates to the operation of a control unit under the boundary condition that the proper function of this control unit can only be ensured by an orderly interaction of multiple applications.

### BACKGROUND INFORMATION

In control units for vehicles, an ever increasing proportion of the functionality is no longer defined by a static arrangement of fixed integrated circuits but by software running on a control unit designed as a computer.

Increasingly, the functionality of these control units also relates to aspects of vehicle operation that are relevant to the type approval of the vehicle. This means that unauthorized changes to the software by the user of the vehicle can lead to the type approval being revoked and must therefore be impeded by technical means. One example of such a change is “chip tuning” which increases the engine power of the vehicle but results in deviations of exhaust emission characteristics or noise behavior from the approved values.

Manipulations of this type may, for example, also lead to the vehicle being subjected to increased wear. If, in the event of a failure of the vehicle, the user restores the original version of the software before having the vehicle repaired, the manipulation may go unnoticed. The user could then receive a repair under warranty or as a gesture of goodwill, even though the user actually forfeited the warranty as a result of the manipulation.

German Patent Application Nos. DE 10 2012 110 559 A1, DE 10 2012 109 619 A1, DE 10 2014 208 385 A1 and DE 10 2012 109 617 A1 describe general related art for the protection of control units from software manipulations.

### SUMMARY

According to the present invention, a method for operating a control unit on which multiple applications are executed is provided. This control unit can in particular be a control unit for a vehicle and/or for a drive unit of a vehicle. Examples of such control units include engine control units, control units for driving dynamics systems (e.g., for the driving dynamics control known as electronic stability program (ESP)) and control units for the at least partially automated control of vehicles in traffic.

An application is in particular understood to mean a program that, when executed on hardware of the control unit, implements at least a portion of the nominal functionality of the control unit. An application comprises at least one code block containing executable program code. In addition, the application may also comprise at least one data block that the program code needs to perform its function. The data block may, for example, contain characteristic maps or other parameters for controllers. For example, a controller may be implemented in a generic manner in program code and may be adapted to a specific vehicle by the aforementioned characteristic maps or other parameters. The program code may, for example, also implement a trained machine learning module, such as a neural network. The data block may then, for example, contain parameters that characterize the behavior of the trainable module. In a neural network, these parameters, for example, comprise weights which are applied to inputs supplied to a neuron or other processing unit, for activation of said neuron or said processing unit.

According to an example embodiment of the present invention, as part of the method, a first code block of a first application is obtained using a reference stored permanently in the control unit, said code block containing executable program code of said application. Using verification information likewise stored permanently in the control unit, a check is carried out as to whether this first code block is in a version corresponding to said verification information. In response to the result of said check being positive, the program code in the first code block is approved for execution.

Permanent storage in the control unit is in particular to be understood as a form of storage that cannot be freely changed by the end user of the control unit or at least cannot be changed without the knowledge and consent of the manufacturer of the control unit or of another body authorized to make changes to the control unit. For this purpose, storage modules or storage media may, for example, be used in which individual bits, bytes or blocks of bytes can be set to new values by an irreversible physical writing process starting from the new condition. An example of this is memory modules in which individual bits are switched by blowing or otherwise destroying electrically conductive structures.

However, permanent storage in the control unit is also, for example, to be understood as storage in a trusted platform module (TPM) or in a hardware security module (HSM). Such storage may be physically changeable afterwards but may be bound to the possession of a particular cryptographic key or other credential.

Obtaining a code block, or in general any block of information, using a reference is in particular to be understood to mean, for example, the retrieval of this block from a programmable memory of the control unit using a memory address given by the reference. However, this is not the only option. The reference may, for example, also be used to load the block from the Internet. If a sufficiently fast Internet connection is available (e.g., via 5G cellular), only minimal functionality must be kept on the control unit itself, analogously to the PXE network boots previously practiced in local networks, and the applications can then always be reloaded in the latest version.

According to an example embodiment of the present invention, at least using a reference in the first code block, a transfer block is obtained, which contains a reference to a further code block of a further application. This further code block contains executable program code of the further application. Using verification information stored in the first code block, a check is carried out as to whether the transfer block is in a version corresponding to said verification information. In response to the result of said check being positive, the further code block of the further application is obtained using the reference in the transfer block.

In the same way, the code block of the further application can then also again contain a reference with which a next transfer block and finally a next code block of a next application can be obtained.

Via the mere requirement that only authorized code be executed, the method can be used to secure the booting process of a control unit to the effect that a mandatory path is specified for the order of the executed applications. Thus, it is not possible for the end user of the control unit to change this order in an unauthorized manner or to suppress the execution of particular applications in an unauthorized manner.

This conversely means that dividing the functionality of the control unit into individual applications that are to be executed consecutively no longer represents a special security risk. Although a monolithic application, which covers the entire functionality of the control unit, can be secured (for example, cryptographically) particularly well against manipulation, it is in turn comparatively cumbersome to update or extend. In particular, several manufacturers often participate in control units for vehicles that cover a wide range of tasks, and in the respective applications. If a monolithic application has to be created in the end, one manufacturer has to merge the contributions from all other manufacturers and has to repeat this with every update of a single component. On the other hand, if the functionalities implemented by several manufacturers are accommodated in multiple applications, the applications can be updated independently of one another. However, without the additional securing described herein, this creates opportunities to intervene in the booting process of the control unit.

A motivation for such interventions by the end-user may, for example, be the fact that some vehicles, such as miniature electric vehicles (also known as “e-scooters”) or electric-motor-assisted bicycles (“pedelecs” or “e-bikes”), are produced for use in many countries but are subject to different regulatory requirements for use in each country. Purely technically, these vehicles are then equipped with all the functions needed in any of the designated countries and are designed for the maximum power and speed required in any of said countries. Only the software in the control unit defines that, for example, the pedal assist of an e-bike in Germany is only active up to a speed of 25 km/h and that activation of the engine is exclusively possible by pedaling but not by operating a throttle grip or other control element by hand. Compliance with these provisions is a mandatory requirement for the e-bike to be legally considered a bicycle and to be used without a driver's license and insurance protection in public traffic. Accordingly, somewhere, the booting process of the e-bike will include an application that uses the country of use to define the scope of what is allowed, before, for example, an application for the drive system then actually allows the e-bike to be driven according to the parameters defined in this way. If the end user now manages to reverse the boot order, the end user can also use the not allowed functions and drive at the technically maximum possible speed. If such an intervention is possible in a few simple steps and without special knowledge or tools, even this abstract possibility can already have considerable consequences for the user, even if the intervention by the user is not intentional: The user is first confronted with an investigation due to driving with a non-registered, non-taxed and non-insured vehicle (and possibly also without a driver's license) and must defend against this accusation.

Advantageously, according to an example embodiment of the present invention, using verification information in the transfer block, a check is carried out as to whether the further code block is in a version corresponding to said verification information. In response to the result of said check being positive, the program code in the further code block is approved for execution. In this way, starting from a single reference stored permanently in the control unit and a single data set stored permanently there with verification information (root of trust), a chain of trust can be built that extends across any number of applications that are to be executed consecutively.

In a particularly advantageous embodiment of the present invention, using the reference in the first code block, the transfer block is not obtained directly, but a reference block is obtained first. Using the verification information stored in the first code block, a check is then carried out as to whether the reference block is in a version corresponding to said verification information. In response to the result of said check being positive, the transfer block is obtained using a reference in the reference block. The reference block may then optionally contain own verification information, which may be used in place of the verification information in the first code block, in order to verify the transfer block. Since there is a chain of trust from the verification information in the first code block to the verification information in the reference block, it is irrelevant for the security level which verification information is used to confirm the transfer block. If the reference block contains own verification information, this creates an even greater granularity as to which entities can modify the boot sequence of the control unit in what way.

The interposition of a reference block in particular facilitates the separation of tasks, for example in the above described scenario in which applications of different manufacturers interact. For example, the reference block may be used to select which application is executed next, but the maintenance and updates of said application may be left to the respective third-party manufacturer.

In the mentioned example of the e-bike, a localization team for each country of use may, for example, be responsible for implementing the legal requirements regarding the use of the e-bike in road traffic into corresponding operating parameters for the e-bike (e.g., regarding the speed or usability of functions). On the other hand, the manufacturer of the e-bike is responsible for ensuring that the e-bike adapts its behavior to the respective country of use.

For example, this scenario can be implemented by creating, for each intended country of use, a transfer block that contains a reference (e.g., a URL) to a localization application for said country of use and to a public cryptographic key of the corresponding localization team. Depending on the intended country of use for a specific model, the manufacturer of the e-bike can then use the reference block to stipulate which of these transfer blocks is selected. Each model of the e-bike can thus be equipped with the same range of transfer blocks; only the reference block is to be changed per model. Updates or other changes to the localization applications do not necessitate any change to the transfer block or any change to the reference block. It is sufficient to store, under the URL stored in the transfer block, a new version with a digital signature that can be confirmed with the public key stored in the transfer block.

According to an example embodiment of the present invention, the verification information may, for example, comprise a hash value. In response to this hash value matching a hash value formed via a code block, transfer block or reference block, it can then be determined that said code block, transfer block or reference block is in a version corresponding to the verification information.

In a particularly advantageous embodiment of the present invention, the verification information comprises at least one public key of an asymmetric cryptosystem. In response to a code block, transfer block or reference block being validly signed with a secret key associated with said public key, it can then be determined that said code block, transfer block or reference block is in a version corresponding to the verification information. Using a public key as verification information has the special advantage that said key can remain the same even if the code block, transfer block or reference block to be verified is changed. If the signature can be confirmed, it is established that it was made with the correct secret key. It is thus established that the code block, transfer block or reference block has been changed by an authorized entity.

With public keys as verification information, it is especially easy to manage in a stepped manner who is authorized to change particular sequences and settings. For example, particular changes may be reserved for only a vehicle manufacturer, while other changes, such as the additional initialization of an electronic hitch, may also be delegated to the road traffic department or the technical inspection association, which approve the retrofitting of this hitch and enter it into the vehicle papers.

In a further particularly advantageous embodiment of the present invention, the first code block, the transfer block and/or the reference block additionally comprises a specification of authorizations for accessing system resources of the control unit and/or for performing actions in or with the control unit. The access of the further application to system resources and/or the performance of actions by the further application is limited according to these authorizations. In this way, the aforementioned division of tasks between manufacturers of different applications can be improved to the effect that mutual impairments and incompatibilities of applications are reduced. At the same time, in particular if a control unit is used in a vehicle, safety tends to always increase if an application can and may ever only do what corresponds to its intended use.

For example, since the widespread introduction of the CAN bus, vehicles have been networked internally such that all sensors, actuators and control units could in principle connect to one another. Prior to this networking being introduced, large cable harnesses were in each case used to create dedicated point-to-point connections for exactly those communications relations that were desired and intended for the vehicle. The aforementioned networking allows a lot more flexibility here, which inter alia makes retrofitting functionality significantly easier. However, it does not only have advantages if, for example, the entertainment system is also in principle able to communicate with driving dynamics systems. The entertainment system may not do so as part of its normal operations but may indeed do so after being hijacked by an attacker. For example, if the implementation of the codec for decoding DAB digital radio is not sufficiently secured, an attacker could, for example, use a specifically built, off-spec data stream to bring the codec into a situation that was never provided during its development. For example, if, according to the specification, a data field is to announce the size of a following block of audio data, the attacker may send 5000 bytes instead of the announced 1000 bytes. If, after the announcement of the 1000 bytes, the codec has also reserved only 1000 bytes of memory, the excess 4000 bytes may override information in the memory that is relevant to the control flow of the codec. The codec then no longer performs its intended task but rather what the attacker packed into the excess 4000 bytes. The attack could be carried out with a sufficiently strong VHF transmitter at an exposed location on many vehicles simultaneously.

However, if the application responsible for the entertainment system is only granted access to the interior speakers and the instrument cluster in the cockpit, but not to driving dynamics systems, the damage imminent in the attack scenario described by way of example can be clearly contained.

Particularly advantageously, according to an example embodiment of the present invention, a specification of authorizations in the context of a predecessor application in each case grants authorizations to a successor application to be executed only at most to the extent to which the predecessor application also has these authorizations. This makes it more difficult to bypass authorization restrictions by executing a further existing application, which may even be validly signed.

Advantageously, by the specification of authorizations, the further application or successor application is excluded from accessing specifically such system resources or from performing specifically such actions that may affect the driving safety and/or a granted type approval of a vehicle. For example, it can thus be prevented that the holder of the vehicle exploits the above-described exemplary gap in the entertainment system of the vehicle or any other security gap in order to “liberate” the vehicle, in the manner of jail-breaking or rooting as is popular with smartphones, from the restrictions defined for technical and legal reasons, and to thus, for example, achieve more engine power at the expense of the general public who suffers from the worsened exhaust emission characteristics and noise behavior.

In a further particularly advantageous embodiment of the present invention, at least one application causes the control unit to provide one or more services that remain active even after the switch to the execution of the further application. The method can then be used to inevitably define an order for starting these services so that a vehicle with the control unit is, for example, always in a defined state after the services have been started.

In the example of the e-bike mentioned above, such a service can, for example, monitor the current driving speed and the pressure on the pedals. From the ratio between the driving speed on the one hand and the pedal pressure on the other hand, the request to activate motor assistance can then, for example, be derived if the maximum speed allowed for the latter is not exceeded. The mandatory path in the boot sequence then ensures that the aforementioned country-specific restrictions are defined before motor assistance is activated.

In a further particularly advantageous embodiment of the present invention, in addition to checking whether a code block is in a version corresponding to verification information, a check is also carried out as to whether a data block required during the execution of said code block is in a version corresponding to verification information. The program code contained in the code block is approved for execution only if the result of said check is also positive. As mentioned above, the specific behavior of the application is often characterized by a data block, which may include, for example, characteristic maps of controllers or weights of neural networks. Accordingly, by manipulating the data block, it is possible to intervene in the functionality of the control unit just as seriously as by manipulating the executable program code. In this respect, it is sometimes still significantly easier, for example for the user of a vehicle, to purposefully manipulate the data block than the program code, which the user cannot understand without special knowledge. The “reverse engineering” of an application present only as a binary object code in terms of which change in the program code could have which effect is a very challenging task. On the other hand, it is clear that in a data block with an engine characteristic map, increasing values that are already high can lead to a power increase of the engine, for example.

The functionality of the described method can be implemented in whole or in part in software. The present invention therefore also relates to a computer program including machine-readable instructions which, when executed on one or more computers, cause the computer(s) to perform one of the methods described. In this sense, control units for vehicles and embedded systems for technical devices that are likewise capable of executing machine-readable instructions are also to be regarded as computers.

Likewise, the present invention also relates to a machine-readable data storage medium and/or to a download product including the computer program. A download product is a digital product that can be transmitted via a data network, i.e., can be downloaded by a user of the data network, and can, e.g., be offered for sale in an online shop for immediate download.

Furthermore, a computer may be equipped with the computer program, with the machine-readable storage medium or with the download product. Said computer can in particular be a control unit for a vehicle and/or for a drive unit of a vehicle.

In a particularly advantageous embodiment of the present invention, said control unit contains a hardware security module (HSM) and/or a trusted platform module (TPM). Said HSM or TPM includes the reference, stored permanently in the control unit, to the first code block of the first application as well as the permanently stored verification information for said first code block. The mentioned modules are particularly secure storage locations for the roots of trust, with which all later code blocks, transfer blocks and reference blocks can be verified.

Further measures improving the present invention are described in more detail below on the basis of the figures, together with the description of the preferred exemplary embodiments of the present invention.

### BRIEF DESCRIPTION OF THE DRAWINGS

FIG. 1 shows an exemplary embodiment of the method 100 for operating a control unit 1, according to the present invention.

FIG. 2 shows an exemplary embodiment of a control unit 1 on which three applications 2, 3, 4 are installed, according to the present invention.

### DETAILED DESCRIPTION OF EXAMPLE EMBODIMENTS

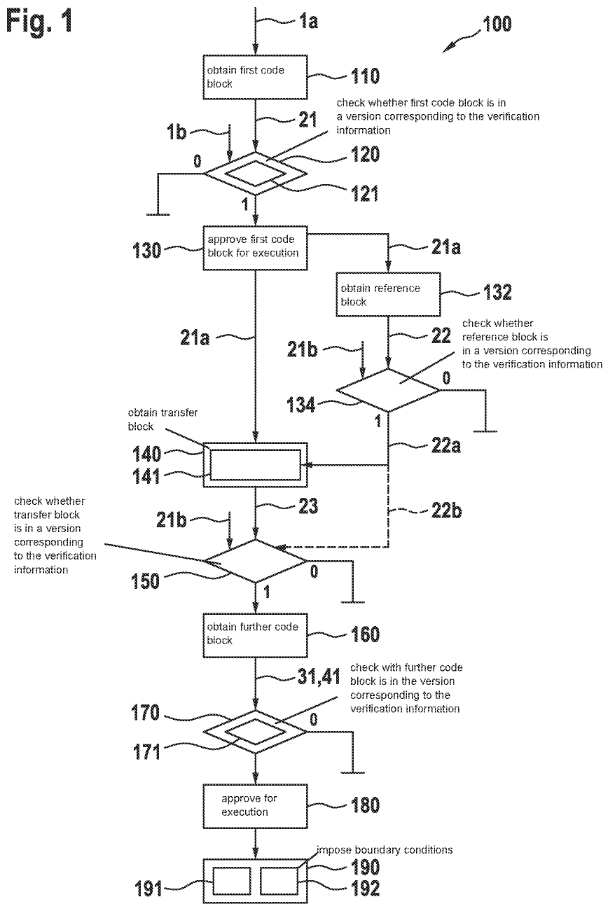

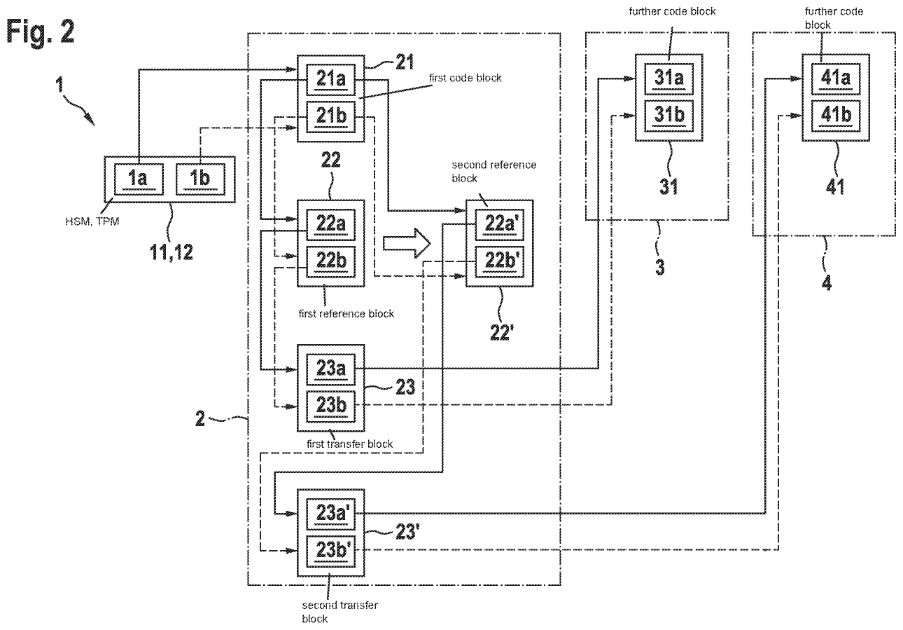

FIG. 1 is a schematic flow chart of an exemplary embodiment of the method 100 for operating a control unit 1, the content of which is shown in greater detail in FIG. 2.

In step 110, using a reference 1a stored permanently in the control unit 1, a first code block 21 of a first application 2 is obtained, said code block containing executable program code of said application 2. In step 120, using verification information 1b likewise stored permanently in the control unit 1, a check is carried out as to whether this first code block 21 is in a version corresponding to said verification information 1b. In this case, according to block 121, a check can also optionally be carried out as to whether a data block required during the execution of the first code block 21 is likewise in a version corresponding to the verification information 1b. If the check for the code block 21 and, where applicable, also for the data block provides a positive result (logical value 1), the program code in the first code block 21 is approved for execution in step 130.

A reference 21a in the code block 21 can now point directly to a transfer block 23, which can then be obtained in step 140. Alternatively, however, the reference 21a may also point to a reference block 22. This reference block is then obtained in step 132, and a check is carried out in step 134 as to whether the reference block 22 is in a version corresponding to the verification information 21b from the first code block 21. If this is the case, a reference 22a in the reference block 22 can be used to obtain the transfer block 23 according to block 141.

In step 150, at least using verification information 21b stored in the first code block 21, a check is carried out as to whether the transfer block 23 is in a version corresponding to said verification information 21b. Instead of directly using the verification information 21b for this purpose, it is also possible to use verification information 22b from a reference block 22, which in turn was confirmed with the verification information 21b of the first code block 21. If the result of said check is positive (logical value 1), the reference 23a in the transfer block 23 is used in step 160 to obtain the further code block 31, 41 of the further application 3, 4.

In step 170, using verification information 23b in the transfer block 23, a check can then be carried out as to whether the further code block 31, 41 is in a version corresponding to said verification information 23b. Analogously to step 120, according to block 171, a check can also be carried out as to whether a data block required during the execution of the code block 31, 41 can also be confirmed with this verification information 23b. If the result of the check for code block 31, 41 and, where applicable, also for the respectively required data block is positive (logical value 1), the program code in the further code block 31, 41 is approved for execution in step 180.

In step 190, boundary conditions regarding authorizations for accessing system resources of the control unit 1 and/or for performing actions in or with the control unit 1 may be imposed on the execution of this program code. These boundary conditions may be set by corresponding specifications in the first code block 21, in the transfer block 23 and/or in the reference block 2. In particular, for example according to block 191, a specification of authorizations in the context of a predecessor application 21 can in each case grant authorizations to a successor application 31, 41 to be executed only at most to the extent to which the predecessor application 21 also has these authorizations.

According to block 192, by the specification of authorizations, the further application or successor application 31, 41 can in particular be excluded, for example, from accessing specifically such system resources or from performing specifically such actions that may affect the driving safety and/or a granted type approval of a vehicle.

FIG. 2 shows, by way of example, the content of a control unit 1, which can be operated according to the method 100 described above. The control unit 1 has a hardware security module (HSM) 11 and/or a trusted platform module (TPM) 12, in which the reference 1a and the verification information 1b are permanently stored.

Using the reference 1a, the first code block 21 of the first application 2 can be obtained. Said first code block can then be confirmed using the verification information 1b. In the example shown in FIG. 2, a reference 21a in the first code block 21 can selectively point to a first reference block 22 or to a second reference block 22′. If the reference 21a points to the first reference block 22, this first reference block 22 can be obtained and confirmed with the verification information 21b in the first code block 21. On the other hand, if the reference 21a points to the second reference block 22′, this second reference block 22′ can be obtained and confirmed with the verification information 21b.

The first reference block 22 points with its reference 22a to the first transfer block 23, which can be confirmed with verification information 22b of the first reference block 22 (or also with verification information 21b of the first code block 21). The first transfer block 23 in turn points with its reference 23a to the code block 31 of the second application 3 and also contains verification information 23b, with which said code block 31 can be confirmed. Analogously to code block 21, the code block 31 contains a reference 31a and verification information 31b.

The second reference block 22′ points with its reference 22a′ to the second transfer block 23, which can be confirmed with verification information 22b′ of the second reference block 22′ (or also with verification information 21b of the first code block 21). The second transfer block 23′ in turn points with its reference 23a′ to the code block 41 of the third application 4 and also contains verification information 23b′, with which this code block 41 can be confirmed. Analogously to code block 21, the code block 41 contains a reference 41a and verification information 41b.

In this way, by merely replacing the first reference block 22 with the second reference block 22′, which only requires a very low volume of data, it can be defined that after the first application 2, the third application 4 is executed in place of the second application 3.

The switch from the second application 3 to the third application 4 as the next application to be executed can alternatively also be brought about by the direct replacement of the first transfer block 23 with the second transfer block 23′.

The third application 4 does not necessarily have to be completely different from the second application 3 but may also be an update of the second application 3, for example.

Optionally, reference blocks 22, 22′ may also refer to data blocks required by the application 2. However, reference blocks 22, 22′ may also refer to key blocks that, analogously to the transfer blocks 23, contain a reference to the data block as well as verification information for the confirmation thereof.

Then, each data block can thus have its own signature source, which can freely define who is authorized to update this data block.

1-15. (canceled)

16. A method for operating a control unit on which multiple applications are executed, the method comprising the following steps:
obtaining, using a reference stored permanently in the control unit, a first code block of a first application, the first code block containing executable program code of the first application;
checking, using verification information stored permanently in the control unit, whether the first code block is in a version corresponding to the verification information stored permanently in the control unit;
approving, in response to a result of the check of the first code block being positive, the program code in the first code block for execution;
obtaining, at least using a reference in the first code block, a transfer block which contains a reference to a further code block of a further application, the further code block containing executable program code of the further application;
checking, at least using verification information stored in the first code block, whether the transfer block is in a version corresponding to the verification information stored in the first code block; and
obtaining, in response to a result of the check of the transfer block being positive, the further code block of the further application using the reference in the transfer block.

17. The method according to claim 16, further comprising:
checking, using verification information in the transfer block, whether the further code block is in a version corresponding to the verification information in the transfer block; and
approving, in response to a result of the check of the further code block being positive, the program code in the further code block for execution.

18. The method according to claim 16, further comprising:
obtaining, using the reference in the first code block, a reference block;
checking, using the verification information stored in the first code block, whether the reference block is in a version corresponding to the verification information stored in the first code block; and
obtaining, in response to a result of the check of the reference block being positive, the transfer block using a reference in the reference block.

19. The method according to claim 16, wherein the verification information permanently stored in the control unit and the verification stored in the first code block each includes at least one hash value, and wherein in response to the hash value stored in the control unit matching a hash value formed via the first code block, it is determined that the first code block is in a version corresponding to the verification information permanently stored in the control unit, and wherein in response to the hash valued stored in the first code block matching a hash value formed via the transfer block, it is determined that the transfer bock is in a version corresponding to the verification information stored in the first code block.

20. The method according to claim 16, wherein the verification information permanently stored in the control unit and the verification information stored in the first code block each includes at least one public key of an asymmetric cryptosystem, and wherein in response to the first code block being validly signed with a secret key associated with the public key in the control unit, it is determined that the first code block is in a version corresponding to the verification information permanently stored in the control unit, and wherein in response to the transfer block being validly signed with a secret key associated the public key in the first code block, it is determined that the transfer block is in a version corresponding to the verification information stored in the first code block.

21. The method according to claim 16, wherein the first code block and/or the transfer block additionally include a specification of authorizations for accessing system resources of the control unit and/or for performing actions in or with the control unit, and wherein the access of the further application to system resources and/or the performance of actions by the further application is limited according to these authorizations.

22. The method according to claim 21, wherein a specification of authorizations in the context of a predecessor application in each case grants authorizations to a successor application to be executed only at most to the extent to which the predecessor application also has the authorizations.

23. The method according to claim 21, wherein, by the specification of authorizations, the further application or successor application is excluded from accessing specifically such system resources or from performing specifically such actions that may affect the driving safety and/or a granted type approval of a vehicle.

24. The method according to claim 16, wherein at least one of the applications causes the control unit to provide one or more services that remain active even after a switch to execution of the further application.

25. The method according to claim 16, wherein in addition to the checking of whether the first code block is in a version corresponding to the verification information permanently stored in the control unit, a check is also carried out as to whether a data block required during the execution of the first code block is in a version corresponding to verification information permanently stored in the control unit, and wherein the program code in the first code block is approved for execution only when the result of the check of the data block is also positive.

26. A non-transitory machine-readable storage medium on which is stored a computer program for operating a control unit on which multiple applications are executed, the computer program, when executed by one or more computers, causing the one or more computers to perform the following steps:
obtaining, using a reference stored permanently in the control unit, a first code block of a first application, the first code block containing executable program code of the first application;
checking, using verification information stored permanently in the control unit, whether the first code block is in a version corresponding to the verification information stored permanently in the control unit;
approving, in response to a result of the check of the first code block being positive, the program code in the first code block for execution;
obtaining, at least using a reference in the first code block, a transfer block which contains a reference to a further code block of a further application, the further code block containing executable program code of the further application;
checking, at least using verification information stored in the first code block, whether the transfer block is in a version corresponding to the verification information stored in the first code block; and
obtaining, in response to a result of the check of the transfer block being positive, the further code block of the further application using the reference in the transfer block.

27. A control unit, comprising:
a computer configured to operating a control unit on which multiple applications are executed, the computer configured to:
obtain, using a reference stored permanently in the control unit, a first code block of a first application, the first code block containing executable program code of the first application;
check, using verification information stored permanently in the control unit, whether the first code block is in a version corresponding to the verification information stored permanently in the control unit;
approve, in response to a result of the check of the first code block being positive, the program code in the first code block for execution;
obtain, at least using a reference in the first code block, a transfer block which contains a reference to a further code block of a further application, the further code block containing executable program code of the further application;
check, at least using verification information stored in the first code block, whether the transfer block is in a version corresponding to the verification information stored in the first code block; and
obtain, in response to a result of the check of the transfer block being positive, the further code block of the further application using the reference in the transfer block.

28. The control unit according to claim 27, further comprising a hardware safety module (HSM) and/or a trusted platform module, which includes the reference stored permanently in the control unit, to the first code block of the first application and the permanently stored verification information for the first code block.
